(19) United States
(12) Patent Application Publication
(10) Pub. No.: US 2019/0133133 A1
(43) Pub. Date: May 9, 2019

(54) SEED COATING FORMULATION

(71) Applicant: IMERYS MINERALS LIMITED, Par Cornwall (GB)

(72) Inventors: Yannick RABOT, Lacroix Falgarde (FR); Dimitris REPPAS, Athens (GR)

(73) Assignee: IMERYS MINERALS LIMITED, Par Cornwall (GB)

(21) Appl. No.: 16/096,882

(22) PCT Filed: Apr. 27, 2017
(86) PCT No.: PCT/EP2017/060086

§ 371 Date: Oct. 26, 2018

(30) Foreign Application Priority Data
Apr. 29, 2016 (EP) 16305506.4

(51) Int. Cl. A01N 59/00; C01F 11/12

(52) U.S. Cl. CPC A01N 59/00; C01P 2004/60; C01F 11/12

(57) ABSTRACT

Use of a silicate mineral in a seed coating formulation, a seed coating formulation comprising a silicate mineral, a seed coated with said seed coating formulation and a method of making a coated seed.

### TECHNICAL FIELD

The present invention relates generally to the use of silicate minerals in seed coating formulations to provide a source of one or more micronutrients such as plant available silicon (PAS), potassium, calcium, sodium and/or magnesium. The present invention thus further relates to seed coating formulations, to seeds coated with said formulations and to methods of making said coated seeds.

### BACKGROUND

Plant seed coatings are often used to provide a source of one or more compounds that may enhance plant germination, growth and/or survival. For example, seeds may be coated with one or more fungicides, bactericides, insecticides, rodenticides, nematocides, miticides or bird repellents. This may, for example, be useful to reduce the amount of chemicals used to obtain a desired effect, for example in comparison to delivering them to the soil in which the seeds are to be grown. Seeds may also be coated with one or more coloured coatings so that they can be easily visualized and/or distinguished from other seeds. Seeds may also be coated such that they are larger, rounder, smoother, heavier and/or more uniform than the original seed. This may, for example, be useful when using automated seed-sowing machinery. It is therefore desirable to provide alternative or improved seed coating formulations. In particular, it is desirable to provide seed coating formulations that provide a source of one or more compounds that enhance plant germination, growth and/or survival.

### SUMMARY

In accordance with a first aspect of the present invention there is provided a seed coating formulation comprising one or more silicate minerals. The seed coating formulation may, for example, additionally comprise a binder.

In certain embodiments, the silicate mineral has a Si availability of at least about 3% according to the acid extraction method. Alternatively or additionally, in certain embodiments, the silicate mineral has a Si availability of at least about 1% according to the alkaline extraction method. Thus, in accordance with a further aspect of the present invention there is provided a seed coating formulation comprising at least one silicate mineral, wherein the silicate mineral has a Si availability of at least about 3% according to the acid extraction method and/or at least about 1% according to the alkaline extraction method. The coating formulation may, for example, additionally comprise a binder.

In accordance with a further aspect of the present invention, there is provided a seed having a coating comprising at least one silicate mineral. The coating may, for example, additionally comprise a binder.

In certain embodiments, the silicate mineral has a Si availability of at least about 3% according to the acid extraction method. Alternatively or additionally, in certain embodiments, the silicate mineral has a Si availability of at least about 1% according to the alkaline extraction method. Thus, in accordance with a further aspect of the present invention there is provided a seed having a coating comprising and at least one silicate mineral, wherein the silicate mineral has a Si availability of at least about 3% according to the acid extraction method and/or at least about 1% according to the alkaline extraction method. The coating may, for example, additionally comprise a binder.

In accordance with a further aspect of the present invention, there is provided a method of making a coated seed, the method comprising coating the seed with a seed coating formulation according to any aspect or embodiment of the present invention.

In accordance with a further aspect of the present invention, there is provided a use of one or more silicate minerals in a seed coating to provide a source of one or more micronutrients. In certain embodiments, the silicate mineral provides a source of plant available silicon (PAS). In certain embodiments, the seed coating comprises a seed coating formulation according to any aspect or embodiment of the present invention.

In certain embodiments of any aspect of the present invention, the silicate mineral has a Si availability of at least about 3% according to the acid extraction method. In certain embodiments, the silicate mineral has a Si availability of at least about 5% according to the acid extraction method. In certain embodiments, the silicate mineral has a Si availability of at least about 10% according to the acid extraction method.

In certain embodiments of any aspect of the present invention, the silicate mineral has a Si availability of at least about 1% according to the alkaline extraction method. In certain embodiments, the silicate mineral has a Si availability of at least about 2% according to the alkaline extraction method.

In certain embodiments of any aspect of the present invention, the silicate mineral is an inosilicate.

In certain embodiments of any aspect of the present invention, the silicate mineral comprises an alkaline earth metal silicate. In certain embodiments, the silicate mineral comprises a calcium silicate. In certain embodiments, the silicate mineral comprises quartz (SiO₂). In certain embodiments, the silicate mineral comprises one or more of wollastonite, mica, diatomite, feldspar and talc. In certain embodiments, the seed coating or seed coating formulation further comprises calcium carbonate (CaCO₃).

In certain embodiments of any aspect of the present invention, the silicate mineral has an average particle size equal to or greater than about 5 μm. In certain embodiments, the silicate mineral has an average particle size equal to or greater than about 10 μm. In certain embodiments, the silicate mineral has an average particle size equal to or less than about 150 μm. In certain embodiments, the silicate mineral has an average particle size equal to or less than about 100 μm.

Certain embodiments of the present invention may provide one or more of the following advantages:
Source of one or more micronutrients (e.g. silicon, potassium, sodium, magnesium, calcium);
Leaching of one or more micronutrients in the close vicinity of the seed;
Reduced amount of compound required to provide a desired amount of one or more micronutrients;
Reduced runoff of compound due to rainwater etc.

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

There is provided herein the use of one or more silicate minerals in a seed coating to provide a source of one or more micronutrients. Without wishing to be bound by theory, it is thought that, upon contact with the soil, the one or more micronutrients are leached from the seed coating to the soil in a form that can be taken up by the seed. The provision of the one or more micronutrients in the seed coating may, for example, enhance seed germination, growth and/or survival. The provision of the one or more micronutrients may, for example, reduce the amount of the one or more micronutrients provided to the seeds to obtain a desired effect, for example in comparison to providing the one or more micronutrients to the soil in free form. The silicate mineral may, for example, particularly provide a source of plant available silicon (PAS). Plant available silicon refers to soluble monosilicic acid (SiO(OH)₂), which is the only form of silicon that can be absorbed by plants. The silicate mineral may, for example, provide a source of potassium, sodium, calcium and/or magnesium. For example, mica, feldspar and/or talc may provide a source for potassium or magnesium.

The term “coating” used herein is to be understood broadly, and is not limited, for example, to uniform coatings or to coatings which cover the entire surface area of a seed. Seeds in which discrete regions of the surface are modified with a coating as described herein will be understood as being coated within the terms of the present invention. The coating may suitably be present in an amount sufficient to provide a source of one or more micronutrients, for example plant available silicon.

Seed Coating Formulations and Coated Seeds

The seed coatings and seed coating formulations disclosed herein comprise one or more silicate mineral(s). Silicate minerals refer to any mineral comprising an anionic silicon group (e.g. oxides or halides). The silicate mineral may, for example, be crystalline. The silicate mineral may, for example, be amorphous.

The anionic silicon group may, for example, be a halide such as hexafluorosilicate ([SiF₆]²⁻). The anionic silicon group may, for example, be an oxide, for example be a nesosilicate ([SiO₄]⁴⁻), an orthosilicic acid (SiO₄H₄), a sorosilicate ([Si₂O₇]⁶⁻), a cyclosilicate ([SiₙO₃ₙ]²ⁿ⁻), an single chain inosilicate ([SiₙO₃ₙ]²ⁿ⁻), a double chain inosilicate ([Si₄ₙO₁₁ₙ]⁶ⁿ⁻), a phyllosilicate ([Si₂ₙO₅ₙ]²ⁿ⁻) or a tectosilicate ([AlₓSi_{y}O_{2x+2y}]^{x-}). In certain embodiments, the silicate mineral comprises an inosilicate (single or double chain). In certain embodiments, the silicate mineral comprises a single chain inosilicate.

The silicate may include one or more positively charged counter ions. The one or more positively charged counter ions may, for example, be one or more metal ions. The one or more metal ions may, for example, be selected from one or more alkali metal ions (e.g. Li⁺, Na⁺, K⁺), one or more alkaline earth metal ions (e.g. Be²⁺, Mg²⁺, Ca²⁺), Ti ions, Cr ions, Mn ions, Fe ions, Co ions, Ni ions, Cu ions, Zn ions and Al ions. In certain embodiments, the silicate mineral comprises an alkaline earth metal silicate. In certain embodiments, the silicate mineral comprises a calcium silicate (e.g. Ca₃SiO₅, Ca₂SiO₄, Ca₃Si₂O₇, CaSiO₃). In certain embodiments, the silicate mineral comprises CaSiO₃.

The silicate mineral may, for example, be selected from phenakite, willemite, forsterite, fayalite, tephroite, pyrope, almandine, spessartine, grossular, andradite, uvarovite, hydrogrossular, zircon, thorite, andalusite, kyanite, sillimanite, dumortierite, topaz, staurolite, norbergite, chondrodite, humite, clinohumite, datolite, titanite, clorotoid, mullite, hemimorphite, lawsonite, ilvaite, epidote, zoisite, clinozoisite, tanzanite, allanite, dollaseite, vesuvianite, benitoite, azinite, beryl, sugilite, cordierite, tourmaline, enstatite, ferrosilite, pigeonite, diopside, hedenbergite, augite, jadeite, aegirine, spodumene, wollastonite, rhodonite, pectolite, anthophyllite, cummingtonite, grunerite, tremolite, actinolite, hornblende, glaucophane, riebeckite, arfvedsonite, serpentine (e.g. antigorite, chrystile, lizardite), clay (e.g. halloysite, kaolinite, illite, montmorillonite, vermiculite, talc, sepiolite, palygorskite, pyrophyllite), mica (e.g. biotite, muscovite, phlogopite, lepidolite, margarite, glauconite), talc, chlorite, diatomite, quartz (e.g. quartz, tridymite, cristobalite, coesite, stishovite), feldspar (e.g. microcline, orthoclase, albite, olidoclase, andesine, anorthite), feldspathoid (e.g. nosean, nepheline, lazurite), petalite, scapolite, analcime, zeolite (e.g. natrolite, erionite, stilbite, mordenite) or a combination thereof.

In certain embodiments, the silicate mineral comprises or is wollastonite, diatomite, mica, feldspar, talc, or combinations thereof. In certain embodiments, the silicate mineral comprises or is wollastonite, diatomite, mica, feldspar or combinations thereof. In certain embodiments, the silicate mineral comprises or is wollastonite, mica, feldspar, talc or combinations thereof. In certain embodiments, the silicate mineral is wollastonite.

In certain embodiments, the seed coating or seed coating formulations may further comprise additional minerals, which may, for example, be associated with the natural source of the silicate mineral. For example, the seed coating or seed coating formulation may further comprise an additional silicate mineral as specified above. For example, the seed coating or seed coating formulation may further comprise calcium carbonate (CaCO₃), cuspidine (3CaO 2SiO₂ CaF₂), plagioclase fledspar (albite (Na, Ca)(Si, Al)₄O₈/anorthite (Ca,Na)(Si,Al)₄O₈), opal (SiO₂/cristobalite SiO₂.xH₂O), diopside (Ca(Mg,Al)(Si,Al)₂O₆), flurorapophyllite (KCa₄(Si₈O₂O)F.8H₂O) or a combination thereof. For example, the seed coating or seed coating formulation may further comprise quartz. For example, the seed coating or seed coating formulation may further comprise calcium carbonate.

When the silicate mineral is obtained from naturally occurring sources, it may be that some mineral impurities will contaminate the ground material. For example, naturally occurring wollastonite may contain small amounts of iron, magnesium and/or manganese substituting for calcium. Thus, in some embodiments, the silicate mineral includes an amount of impurities. In general, however, the silicate mineral used in the invention will contain less than about 5% by weight, or less than about 1% by weight, of other mineral impurities.

The silicate mineral used in the present invention may be obtained from a natural source by grinding (wet and/or dry process). For example, the silicate mineral may be obtained by crushing and then grinding a mineral source such as wollastonite, diatomite, mica or feldspar, which may be followed by a particle size classification step, in order to obtain a product having the desired degree of fineness. Other techniques such as bleaching, flotation and magnetic separation may also be used to obtain a product having the desired degree of fineness and/or colour. The mineral may, for example, undergo a particle size classification procedure, e.g. screening, centrifuging, milling, grinding or a combination thereof). The particulate solid material may be ground autogenously, i.e. by attrition between the particles of the solid material themselves, or, alternatively, in the presence of a particulate grinding medium comprising particles of a different material from the mineral to be ground. The silicate mineral may, for example, be milled and/or dried. These processes may be carried out with or without the presence of a dispersant and biocides, which may be added at any stage of the process. Wet grinding of mineral involves the formation of an aqueous suspension of the mineral which may then be ground, optionally in the presence of a suitable dispersing agent. The mineral may, for example, be dried.

The silicate mineral may, for example, be ground and/or milled such that they pass a 300 μm sieve. In other words, the maximum particle size of the silicate mineral may be no more than about 300 μm.

The silicate mineral may, for example, have an average particle size equal to or greater than about 5 μm. For example, the silicate mineral may have an average particle size equal to or greater than about 6 μm or equal to or greater than about 7 μm or equal to or greater than about 8 μm or equal to or greater than about 9 μm or equal to or greater than about 10 μm or equal to or greater than about 12 μm or equal to or greater than about 14 μm or equal to or greater than about 15 μm or equal to or greater than about 17 μm or equal to or greater than about 19 μm or equal to or greater than about 20 μm or equal to or greater than about 22 μm or equal to or greater than about 24 μm or equal to or greater than about 25 μm or equal to or greater than about 30 μm or equal to or greater than about 35 μm or equal to or greater than about 40 μm or equal to or greater than about 45 μm or equal to or greater than about 50 μm or equal to or greater than about 55 μm. The silicate mineral may, for example, have an average particle size equal to or less than about 150 μm or equal to or less than about 140 μm or equal to or less than about 130 μm or equal to or less than about 120 μm or equal to or less than about 110 μm or equal to or less than about 100 μm or equal to or less than about 90 μm or equal to or less than about 80 μm or equal to or less than about 70 μm or equal to or less than about 60 μm. The silicate mineral may, for example, have an average particle size ranging from about 5 μm to about 150 μm or from about 10 μm to about 100 μm or from about 15 μm to about 75 μm or from about 20 μm to about 50 μm.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The average (mean) particle size (d₅₀) is the value determined in this way of the particle e.s.d at which there are 50% by weight of the particles which have an equivalent spherical diameter less than that d₅₀ value.

The silicate mineral may, for example, have a Si availability equal to or greater than about 3% according to the acid extraction method. For example, the silicate mineral may have a Si availability equal to or greater than about 4% or equal to or greater than about 5% or equal to or greater than about 6% or equal to or greater than about 7% or equal to or greater than about 8% or equal to or greater than about 9% or equal to or greater than about 10% or equal to or greater than about 11% or equal to or greater than about 12% or equal to or greater than about 13% or equal to or greater than about 14% or equal to or greater than about 15% or equal to or greater than about 16%, according to the acid extraction method. The silicate mineral may, for example, have a Si availability equal to or less than about 50% or equal to or less than about 40% or equal to or less than about 30% or equal to or less than about 25% or equal to or less than about 20% or equal to or less than about 18% according to the acid extraction method. For example, the silicate mineral may have a Si availability ranging from about 3% to about 50% or from about 5% to about 40% or from about 6% to about 30% or from about 8% to about 25% or from about 10% to about 25% or from about 12% to about 20%, according to the acid extraction method.

The acid extraction method (NIAES, 1987) is disclosed in Masayoshi Koshino: Second Revision of The Methods of Analysis of Fertilizers (Details), page 144-146, Yokendo, Tokyo (1988), the contents of which are incorporated herein by reference. The method uses a 1 g test portion of the silicate mineral, which was agitated with 150 ml of HCl for at about 30° C. for 1 hour and then filtered once cooled to room temperature. Si availability was determined with the use of extra HCl, potassium fluoride solution, which transforms soluble silica to flurosilicic acid (H₂SiF₆), which reacts with added potassium chloride to form a heavy precipitate of potassium silicofluroide (K₂SiF₆). This precipitate is titrated with alkali (K₂SiF₆+4NaOH->2KF+4NaF+H₄SiO₄). The method is further described in the examples below.

The silicate mineral may, for example, have a Si availability equal to or greater than about 1% according to the alkaline extraction method. For example, the silicate mineral may have a Si availability equal to or greater than about 1.5% or equal to or greater than about 2% or equal to or greater than about 2.5% or equal to or greater than about 3% or equal to or greater than about 3.5% or equal to or greater than about 4% or equal to or greater than about 4.5% or equal to or greater than about 5% or equal to or greater than about 5.5% or equal to or greater than about 6%, according to the alkaline extraction method. The silicate mineral may, for example, have a Si availability equal to or less than about 20% or equal to or less than about 15% or equal to or less than about 10% or equal to or less than about 8%, according to the alkaline extraction method. For example, the silicate mineral may have a Si availability ranging from about 1% to about 20% or from about 2% to about 15% or from about 2% to about 10%, according to the alkaline extraction method.

The alkaline extraction method is described in Sebastian et al., Journal of AOAC International, Vol. 96, No. 2, 2013, which is incorporated herein by reference. A 0.2 g test portion of the silicate mineral was added to 100 ml of Na₂CO₃ solution (0.094 M) and 100 ml of NH₄NO₃ solution (0.20 M) and agitated for 1 hour. The samples remained undisturbed for 5 days before Si availability was determined colorimetrically using ammonium molubdate complex on a U2001 Hitachi Spectrophotometer at a wavelength of 660 nm. Tartic acid was added to complex all the phosphorus in solution. The standard silicon curve was 0, 0.5 1.0 and 2.0 mg/I.

The silicate mineral may, for example, be present in the seed coating or seed coating formulation in an amount ranging from about 10 wt % to about 90 wt %. For example, the silicate mineral may be present in the seed coating formulation in an amount ranging from about 20 wt % to about 80 wt % or from about 30 wt % to about 70 wt % or from about 40 wt % to about 60 wt %.

The seed coating or seed coating formulation may, for example, further comprise one or more binders. The binder may, for example, be a natural binder, for example selected from sugars, gums (e.g. guar, xanthan, carageenan), gelatin, starch, cellulose (e.g. carboxymethylcellulose, methylcellulose), pectin, pullulan, chitin, chitosan, alginate compositions, or derivatives and/or combinations thereof. The binder may, for example, be a synthetic binder, for example a synthetic polymer. For example, the binder may be selected from polylactic acid, polycaprolactone, polyhydroxybutyrate, polyacrylamide, poly(methacrylic acid), polyethylene glycol, polyethyleneoxide, polyglycerol, polytetrahydrofuran, polyamide, polyvinyl alcohol, polyvinyl pyrrolidone, vinyl acetate-ethylene copolymer, vinyl acetate homopolymer, vinylidene chloride, vinyl acetate-acrylic copolymer, vinyacrylic, poly(acrylic acid), acrylic, ethylene-vinyl chloride, vinyl ether maleic anhydride, butadiene styrene, or derivatives and/or combinations thereof. For example, the binder may be a polyvinyl polymer. The binder may, for example, be biodegradable.

The binder may, for example, be present in the seed coating or seed coating formulation in an amount ranging from about 1 wt % to about 90 wt %. For example, the binder may be present in the seed coating or seed coating formulation in an amount ranging from about 2 wt % to about 80 wt % or from about 5 wt % to about 70 wt % or from about 5 wt % to about 50 wt % or from about 5 wt % to about 45 wt % or from about 5 wt % to about 40 wt %.

The seed coatings or seed coating formulations may, for example, further comprise one or more additional agents. For example, the seed coatings or seed coating formulations may, for example, comprise one or more plasticizers, surfactants, dispersants, pigments, colorants, fillers, slip-agents, texture-improving agents, antioxidants, anti-static agents, anti-block agents, moisture barrier additives, gas barrier additives, fertilizers, biocides, pesticides, insecticides, fungicides, herbicides, nematocides, inoculants, disinfectants, repellants, macronutrients, micronutrients, plant growth regulators, or combinations thereof. One or more of the additional agents may, for example, prevent aggregation of the seeds.

The additional agents, may each, for example, be present in the seed coating or seed coating formulation in an amount ranging from about 0.1 wt % to about 50 wt % or from about 0.5 wt % to about 40 wt % or from about 1 wt % to about 20 wt % or from about 1 wt % to about 10 wt % or from about 1 wt % to about 5 wt %.

The coating may, for example, have an average thickness ranging from about 1 μm to about 2 mm. For example, the coating may have an average thickness ranging from about 5 μm to about 1.5 mm or from about 10 μm to about 1 mm or from about 10 μm to about 0.5 mm. For example, the coating may have an average thickness ranging from about 10 μm to about 450 μm or from about 15 μm to about 400 μm or from about 20 μm to about 350 μm or from about 30 μm to about 300 μm or from about 40 μm to about 300 μm or from about 50 μm to about 250 μm or from about 100 μm to about 200 μm or from about 100 μm to about 150 μm.

Any type of seed, for example seeds to grow plants, flowers, fruits or vegetables, may be coated as described herein. For example, the seed may be one or more of lettuce, alfalfa, sugar beet, radish, onion, celery, cucumber, carrot, spinach, tomato, cabbage, cereal, grains, corn, cotton and combinations thereof.

Methods of Making Seed Coating Formulations and Methods of Coating Seeds

A method of making a seed coating formulation as described herein is also provided herein. The method may, for example, comprise combining and/or mixing/blending the components of the seed coating formulation using methods known to those skilled in the art. The seed coating formulation may, for example, be a liquid. The seed coating formulation may, for example, be a solution or a suspension or a dispersion. For example, the seed coating formulation may be an aqueous solution or an aqueous suspension or an aqueous dispersion. The minerals may, for example, be sprayed in powder or dispersion separately from the binder.

A method for making a coated seed and a method for coating a seed is also provided herein. The method may, for example, comprise contacting a seed with a seed coating formulation as described herein, including all embodiments thereof. The method may, for example, comprise coating a seed with a seed coating formulation as described herein.

The method may, for example, comprise contacting a slurry of the seed coating formulation and the seeds and then drying the seed coating formulation. The method may, for example, comprise mixing the slurry of the seed coating formulation and the seeds.

The method may, for example, comprise coating the seeds using a batch coating drum and/or a continuous coating drum and/or a rotary coater and/or a pan coater and/or a rotary dry coater. Drying may occur simultaneously or after coating of the seeds with the seed coating formulation.

The method may, for example, comprise spraying the seeds with a seed coating formulation as described herein. The method may, for example, further comprise drying the seed coating formulation on the seeds. The drying may, for example, occur simultaneously to or after application of the seed coating formulation to the seeds. This method may, for example, enable more uniform coatings to be applied to the seeds and/or may reduce loss of the seed coating or seed coating formulation during application. The method may, for example, comprise coating the seeds using an air suspension apparatus. The method may, for example, comprise spraying the coating in powder or dispersion separately from any binder.

The method may, for example, comprise forming one or more layers, for example two, three, four, five, six, seven, eight, nine or ten or more layers on each seed. Each layer may, for example, comprise the same or a different seed coating formulation. For example, the seed coating formulation as described herein (comprising a silicate mineral) may be the external layer of the seed coating.

### Examples

Acid Extraction Method

### (1) Summary

This test method is applicable to fertilizers containing no silica gel fertilizers. Extract by adding hydrochloric acid (1+23) to an analytical sample, add hydrochloric acid, potassium chloride and potassium fluoride solution and cool in a refrigerator, and then filter after forming precipitate as potassium silicofluoride. Put the precipitate in water and heat, and measure by neutralization titration to obtain the hydrochloric acid (1+23) soluble silicic acid (soluble silicic acid (S—Si02)) in an analytical sample.

Reagents:

Reagents are as shown below:

1) 0.1 Mol/L-0.2 Mol/L Sodium Hydroxide Solution:

Transfer about 30 mL of water to a polyethylene bottle, dissolve about 35 g of sodium hydroxide specified in JIS K 8576 by adding in small portions while cooling, seal tightly and leave at rest for 4-5 days. Transfer 5.5 mL-11 mL of the supernatant to a ground-in stoppered storage container, and add 1,000 mL of water containing no carbonic acid.

Standardization:

Dry sulfarnic acid reference material for volumetric analysis specified in JIS K 8005 by leaving at rest in a desiccator at no more than 2 kPa for about 48 hours, then transfer about 2.5 g to a weighing dish, and measure the mass to the order of 0.1 mg. Dissolve with a small amount of water, transfer to a 250-mL volumetric flask, and add water up to the marked line. Transfer a predetermined amount of the solution to a 200-mL-300-mL Erlenmeyer flask, add a few drops of bromothymol blue solution mg/100 mL) as an indicator, and titrate with 0.1 mol/L-0.2 mol/L sodium hydroxide solution until the colour of the solution becomes green. Calculate the factor of a 0.1 mol/L-0.2 mol/L sodium hydroxide solution by the following formula:

Factor of 0.1 mol/L-0.2 mol/L sodium hydroxide solution (t)=(W×A×0.01/97.095)×(V1/V2)×(1,000/V3)×(1/C)

W: Mass (g) of sulfarnic acid sampled

A: Purity (%) of sulfamic acid

V1: Volume (mL) of sulfarnic acid solution transferred

V2: Constant volume (250 mL) of sulfamic acid solution

V3: Volume (mL) of 0.1 mol/L-0.2 mol/L sodium hydroxide solution needed for titration

C: Set concentration (mol/L) of 0.1 mol/L-0.2 mol/L sodium hydroxide solution

2) Hydrochloric Acid:

A JIS Guaranteed Reagent specified in JIS K 8180 or a reagent of equivalent quality.

3) Potassium Chloride:

A JIS Guaranteed Reagent specified in JIS K 8121 or a reagent of equivalent quality.

4) Potassium Chloride Solution:

Add 250 mL of ethanol to 750 mL of water to mix, and add 150 mL of potassium chloride to dissolve. Add a few drops of methyl red solution (0.1 g/100 mL) as an indicator and drop hydrochloric acid until the colour of the solution becomes red to make it acidic. After leaving at rest for 1 day, neutralize with the 0.1 mol/L-0.2 mol/L sodium hydroxide solution.

5) Potassium Fluoride Solution:

Dissolve 58 g of potassium fluoride specified in JIS K 8815 in 1,000 mL of water.

6) Methyl Red Solution (0.1 g/100 mL):

Dissolve 0.10 g of methyl red specified in JIS K 8896 in 100 mL of ethanol (95) specified in JIS K 8102.

7) Phenolphthalein Solution (1 g/100 mL):

Dissolve 1 g of phenolphthalein specified in JIS K 8799 in 100 mL of ethanol (95) specified in JIS K 8102.

The reagents should be stored in a container made of polyethylene, etc. that contains no silicon.

Apparatus and Instruments:

Apparatus and instruments are as follows:
Constant-temperature rotary shaker: A constant-temperature rotary shaker that can rotate a 250-mL volumetric flask, set up in a thermostat adjustable to 30° C.±1° C., upside down at 30-40 revolutions/min.
Hot plate: A hot plate whose surface temperature can be adjusted up to 250° C.

Test Procedures

(4.1) Extraction:

Conduct extraction as shown below.

a) Weigh 1 g of an analytical sample to the order of 1 mg, and transfer to a 250-mL volumetric flask.

b) Add 150 mL of hydrochloric acid heated up to about 30° C., and shake to mix at 30-40 revolutions/min (30° C.±1° C.) for 1 hour.

c) After standing to cool, add water up to the marked line.

d) Filter with Type 3 filter paper to make the sample solution.

(4.2) Measurement:

Conduct measurement as shown below.

a) Transfer a predetermined volume (the equivalents of 20 mg-50 mg as SiO₂ and no more than 25 mL of liquid volume) to a 200-mL beaker made of polyethylene.

b) Add about 10 mL of hydrochloric acid and about 15 mL of potassium fluoride solution, and further add about 2 g of potassium chloride to dissolve, and then cool in a refrigerator for about 30 minutes to form the precipitate of potassium fluoride.

c) Filter with a Gooch crucible made of polyethylene topped with Type 6 filter paper, and wash the container 3 times with potassium chloride solution, then move the whole precipitate into the crucible, and further wash 6-7 times with a small amount of potassium chloride solution.

d) Move the precipitate on the filter together with the filter paper into a 300-mL tall beaker with water, and further add water to make about 200 mL and heat it up to 70° C.-80° C. on a hot plate.

e) Add a few drops of phenolphthalein solution (1 g/100 mL) to the sample solution as an indicator and titrate with the 0.1 mol/L-0.2 mol/L sodium hydroxide solution until the color of the solution becomes light red.

f) Calculate soluble silicic acid (δ-Si02) (available Si) by the following formula.

Soluble silicic acid (S—SiO₂) (% (mass fraction)) in an analytical sample=Vs×C×f×(V4/V5)×(15.021/W)×(100/1,000)

Vs: Volume of the 0.1 mol/L-0.2 mol/L sodium hydroxide solution required for titration

C: Set concentration (mol/L) of 0.1 mol/L-0.2 mol/L sodium hydroxide solution

f: Factor of 0.1 mol/L-0.2 mol/L sodium hydroxide solution

V4: Predetermined volume (mL) of the extract in (4.1) c)

V5: Volume (mL) of the extract transferred in (4.2) a)

W: Mass (g) of an analytical sample

Alkaline Extraction Method

The method described in Sebastian et al., Journal of AOAC International, Vol. 96, No. 2, 2013, page 251 to 259, the contents of which are incorporated herein by reference, was followed.

Results

Samples of the silicate minerals defined in Table 1 were obtained and milled to pass a 300 μm sieve. Samples that already passed the 300 μm sieve were not further milled.

The major mineralogical phases of each sample was determined by X-ray diffraction. The Si availability of each sample was determined using the acid extraction method and the alkaline extraction method described above. The results are shown in Table 2.

TABLE 1

| | | | Sample as | | Sample after | | |
|---|---|---|---|---|---|---|---|
| | | | received | | milling | | |
| | | | +200 mesh | d₅₀ | +200 mesh | d₅₀ | |
| SAMPLE TYPE | SiO₂ % | Si % | (%) | (μm) | (%) | (μm) | Major mineralogical phases |
| Diatomite 1 | 89.31 | 41.75 | 0 | 12.55 | — | — | Amorphous phase |
| | | | | | | | Smectite |
| | | | | | | | Calcite CaCO₃ |
| | | | | | | | Dolomite CaMg(CO₃)₂/Ankerite |
| | | | | | | | Ca(Fe,Mg)(CO₃)₂ |
| Diatomite 2 | 68.39 | 31.97 | 0 | 12.78 | — | — | Amorphous phase |
| | | | | | | | Calcite CaCO₃ |
| | | | | | | | Aragonite CaCO₃ |
| | | | | | | | Quartz SiO₂ |
| | | | | | | | Aluminum Fluoride AlF₃ |
| | | | | | | | Mica/illite |
| Diatomite 3 | 92.33 | 43.16 | 0 | 3.24 | — | — | Amorphous phase |
| | | | | | | | Halite NaCl |
| Diatomite/Calcite | 68.73 | 32.13 | — | — | 0 | 8.14 | Amorphous phase |
| | | | | | | | Calcite CaCO₃ |
| | | | | | | | Aragonite CaCO₃ |
| | | | | | | | Quartz SiO_{2,} |
| | | | | | | | Dolomite CaMg(CO₃)₂/ankerite |
| | | | | | | | Ca(Fe,Mg)(CO₃)₂ |
| Opal C/T | 88.83 | 41.52 | 15.88 | 37.37 | — | — | Opal SiO₂•/cristobalite SiO₂•xH₂O |
| Diatomite 4 | 89.82 | 41.99 | 0 | 17.12 | — | — | Amorphous phase |
| Diatomite 5 | 85.53 | 39.98 | 0 | 13.06 | — | — | Amorphous phase |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| | | | | | | | Calcite CaCO₃ |
| Expanded perlite | 76.88 | 35.94 | 92.81 | — | 0 | 4.8 | Amorphous phase |
| high in quartz | | | | | | | Quartz SiO_{2,} |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| | | | | | | | Biotite |
| | | | | | | | (K,Na)(Mg,Fe,Ti)₃(Si,Al)₄O₁₀(OH,O) |
| Perlite fines | 71.09 | 33.23 | 0 | 6.17 | — | — | Amorphous phase |
| | | | | | | | Quartz SiO₂ |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| | | | | | | | K-feldspar [sanidine K(Si₃Al)₄O₈/ |
| | | | | | | | orthoclase KAlSi₃O₈] |
| | | | | | | | Biotite |
| | | | | | | | (K,Na)(Mg,Fe,Ti)₃(Si,Al)₄O₁₀(OH,O)₂ |
| Perlite | 75.08 | 35.10 | 92.52 | — | 0 | 7.39 | Quartz SiO₂ |
| commercial | | | | | | | Plagioclase feldspar [albite |
| sample | | | | | | | (Na,Ca)(Si,Al)₄O₈/anorthite |
| | | | | | | | (Ca,Na)(Si,Al)₄O₈] |
| Blast Furnace | — | — | 3.4 | 15.25 | — | — | Quartz SiO₂/Carbon C |
| Slag | | | | | | | Anorthoclase (Na,K)(Si,Al)O₈ |
| Calcium Silicate | 47.52 | 22.21 | 100 | — | 0 | 6.89 | Larnite Ca₂SiO₄ |
| Slag | | | | | | | Calcium Iron Oxide 2CaO Fe₂O₃/ |
| | | | | | | | Calcium Aluminum Iron Oxide |
| | | | | | | | Ca₂(AlFe)O₅ |
| | | | | | | | Lithium manganese iron oxide |
| | | | | | | | Li_{1.5}MnFe₂O₄ |
| | | | | | | | Forsterite Mg₂SiO₄ |
| Wollastonite 1 | 42.21 | 19.73 | 84.26 | — | 3.4 | 5.69 | Calcium Silicate CaSiO₃ |
| | | | | | | | Quartz SiO₂ |
| | | | | | | | Cuspidine 3CaO 2SiO₂ CaF₂ |
| | | | | | | | Calcite CaCO₃ |
| | | | | | | | Wollastonite CaSiO_{3,} |
| Wollastonite 2 | 52.39 | 24.49 | 0 | 8.37 | — | — | Parawollastonite CaSiO₃ |
| | | | | | | | Calcite CaCO₃ |
| | | | | | | | Quartz SiO₂ |
| Wollastonite 3 | 48.49 | 22.67 | 0 | 10.08 | — | — | Parawollastonite CaSiO₃ |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| Wollastonite 4 | 52.19 | 24.40 | 0 | 12.06 | — | — | Parawollastonite CaSiO₃ |
| | | | | | | | Calcite CaCO₃ |
| | | | | | | | Quartz SiO₂ |
| Wollastonite 5 | 53.58 | 25.05 | | | 17.62 | 23.00 | Parawollastonite CaSiO₃ |
| | | | | | | | Calcite CaCO₃ |
| | | | | | | | Opal SiO₂•/cristobalite SiO₂•xH₂O |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| Wollastonite 6 | 53.00 | 24.77 | 2.56 | 20.03 | — | — | Wollastonite CaSiO₃ |
| | | | | | | | Quartz SiO₂ |
| | | | | | | | Diopside Ca(Mg,Al)(Si,Al)₂O₆ |
| | | | | | | | Calcite CaCO₃ |
| Wollastonite 7 | 53.07 | 24.81 | — | — | 42.78 | 59.14 | Wollastonite CaSiO₃ |
| | | | | | | | Calcite CaCO₃ |
| | | | | | | | Quartz SiO₂ |
| | | | | | | | Diopside Ca(Mg,Al)(Si,Al)₂O₆ |
| Wollastonite 8 | 52.51 | 24.55 | 0.53 | 16.8 | — | — | Wollastonite CaSiO₃ |
| | | | | | | | Calcite CaCO₃ |
| | | | | | | | Quartz SiO₂ |
| | | | | | | | Diopside Ca(Mg,Al)(Si,Al)₂O₆ |
| Vermiculite | 39.20 | 18.32 | — | — | 0 | 9.94 | Wollastonite CaSiO₃ |
| | | | | | | | Calcite CaCO₃ |
| | | | | | | | Quartz SiO₂ |
| | | | | | | | Diopside Ca(Mg,Al)(Si,Al)₂O₆ |
| | | | | | | | Fluorapophyllite |
| | | | | | | | KCa4(Si8O20)F•8H2O |
| Exfoliated | 39.20 | 18.32 | — | — | — | — | Hydrobiotite |
| vermiculite | | | | | | | K(Mg,Fe)₆(Si,Al,Fe)₈O₂₀(OH)₄•4H₂O |
| | | | | | | | Calcite CaCO_{3,} |
| | | | | | | | Smectite |
| | | | | | | | Augite Ca(Mg,Fe)Si₂O6 |
| | | | | | | | Anatase TiO₂ |
| | | | | | | | Plagioclase feldspar [albite |
| | | | | | | | (Na,Ca)(Si,Al)₄O₈/anorthite |
| | | | | | | | (Ca,Na)(Si,Al)₄O₈], |
| | | | | | | | Magnesioriebeckite |
| | | | | | | | (Na,Ca)₂(Mg,Fe)₅Si₈O₂₂(OH)₂ |
| | | | | | | | Phlogopite KMg₃(Si₃Al)O₁₀(OH)₂ |
| Zeolite | 70.69 | 33.04 | 18.65 | 34.34 | — | — | Clinoptilolite |
| | | | | | | | (Na,K)₄CaAl₆Si₃₀O₇₂•24H₂O/ |
| | | | | | | | Heulandite CaAl₂Si7O₁₈•6H₂O |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| | | | | | | | Opal/C SiO₂•xH₂O/cristobalite SiO₂ |
| | | | | | | | Quartz SiO₂ |
| Kaolinite 1 | 46.61 | 21.79 | 0 | 3.6 | — | — | Kaolinite Al₂Si₂O₅(OH)₄ |
| | | | | | | | Quartz SiO₂ |
| | | | | | | | Mica/illite |
| | | | | | | | Nepheline NaAlSiO₄ |
| Kaolinite 2 | 44.89 | 20.98 | 0 | 3.2 | — | — | Kaolinite Al₂Si₂O₅(OH)₄ |
| Bentonite 1 | 62.09 | 29.02 | — | — | 7.28 | 24.44 | Smectite |
| | | | | | | | Quartz SiO₂ |
| | | | | | | | Anorthoclase (Na,K)(Si,Al)O₈ |
| | | | | | | | Calcite CaCO₃ |
| | | | | | | | Plagioclase feldspar [albite |
| | | | | | | | (Na,Ca)(Si,Al)₄O₈/anorthite |
| | | | | | | | (Ca,Na)(Si,Al)₄O₈] |
| | | | | | | | Mica/illite |
| Bentonite 2 | 60.56 | 28.31 | 7.49 | 27.49 | — | — | Smectite |
| | | | | | | | Quartz SiO₂ |
| | | | | | | | Anorthoclase (Na,K)(Si,Al)O₈ |
| | | | | | | | Calcite CaCO₃ |
| | | | | | | | Mica/illite |
| | | | | | | | Plagioclase feldspar [albite |
| | | | | | | | (Na,Ca)(Si,Al)₄O₈/anorthite |
| | | | | | | | (Ca,Na)(Si,Al)₄O₈], Clinoptilolite |
| | | | | | | | (Na,K)₄CaAl₆Si₃₀O₇₂•24H₂O |
| Bentonite 3 | 51.05 | 23.86 | — | — | 5.42 | 19.11 | Smectite |
| | | | | | | | Calcite CaCO₃ |
| | | | | | | | Dolomite CaMg(CO₃)₂/ankerite |
| | | | | | | | Ca(Fe,Mg)(CO₃)₂ |
| | | | | | | | Quartz SiO₂ |
| | | | | | | | Opal/C SiO₂•xH₂O/cristobalite SiO₂ |
| | | | | | | | K-feldspar [sanidine K(Si₃Al)₄O₈/ |
| | | | | | | | orthoclase KAlSi₃O₈] |
| | | | | | | | Mica/illite |
| | | | | | | | Hematite Fe₂O₃/pyrite FeS₂ |
| | | | | | | | Gypsum CaSO₄•2H₂O |
| Bentonite 4 | 50.05 | 23.40 | 3.74 | 19.75 | — | — | Smectite |
| | | | | | | | Calcite CaCO₃ |
| | | | | | | | Dolomite CaMg(CO₃)₂/ankerite |
| | | | | | | | Ca(Fe,Mg)(CO₃)₂ |
| | | | | | | | Quartz SiO₂ |
| | | | | | | | K-feldspar [sanidine K(Si₃Al)₄O₈/ |
| | | | | | | | orthoclase KAlSi₃O₈] |
| | | | | | | | Opal/C SiO₂•xH₂O/cristobalite SiO₂ |
| | | | | | | | Anatase TiO₂ |
| | | | | | | | Hematite Fe₂O₃/pyrite FeS₂ |
| | | | | | | | Mica/illite |
| | | | | | | | Gypsum CaSO₄•2H₂O |
| Bentonite 5 | 59.85 | 27.98 | — | — | 5.81 | 20.55 | Smectite |
| | | | | | | | Quartz SiO₂ |
| | | | | | | | Calcite CaCO₃ |
| | | | | | | | Opal/C SiO₂•xH₂O/cristobalite SiO₂ |
| | | | | | | | K-feldspar [sanidine K(Si₃Al)₄O₈/ |
| | | | | | | | orthoclase KAlSi₃O₈] |
| | | | | | | | Mica/illite |
| | | | | | | | Clinoptilolite |
| | | | | | | | (Na,K)₄CaAl₆Si₃₀O₇₂•24H₂O |
| | | | | | | | Hematite Fe₂O₃/pyrite FeS₂ |
| Bentonite 6 | 58.61 | 27.40 | | 19.64 | — | — | Smectite |
| | | | | | | | Quartz SiO₂ |
| | | | | | | | Calcite CaCO₃ |
| | | | | | | | Opal/C SiO₂•xH₂O/cristobalite SiO₂ |
| | | | | | | | K-feldspar [sanidine K(Si₃Al)₄O₈/ |
| | | | | | | | orthoclase KAlSi₃O₈] |
| | | | | | | | Clinoptilolite |
| | | | | | | | (Na,K)₄CaAl₆Si₃₀O₇₂•24H₂O |
| | | | | | | | Mica/illite |
| | | | | | | | Hematite Fe₂O₃/pyrite FeS₂ |
| Talc/Chlorite | 51.89 | 24.26 | 0 | 9.56 | — | — | Talc Mg₃Si₄O₁₀(OH)_{2,} |
| | | | | | | | Clinochlore |
| | | | | | | | (Mg,Fe)₆(Si,Al)₄O₁₀(OH)_{8,} |
| | | | | | | | Dolomite CaMg(CO₃)₂/ankerite |
| | | | | | | | Ca(Fe,Mg)(CO₃)_{2,} |
| | | | | | | | Quartz SiO₂ |
| | | | | | | | Calcite CaCO₃ |
| Talc | 60.94 | 28.49 | 0 | 2.74 | — | — | Talc Mg₃Si₄O₁₀(OH)₂ |
| | | | | | | | Dolomite CaMg(CO₃)₂/ankerite |
| | | | | | | | Ca(Fe,Mg)(CO₃)₂ |
| | | | | | | | Clinochlore |
| | | | | | | | (Mg,Fe)₆(Si,Al)₄O₁₀(OH)₈ |

TABLE 2

| | Alkaline | Acid |
|---|---|---|
| | extraction | extraction |
| SAMPLE TYPE | % Si | % Si |
| Diatomite 1 | 0.41 | 0.51 |
| Diatomite 2 | 0.26 | 0.17 |
| Diatomite 3 | 0.31 | 0.34 |
| Diatomite/Calcite | 0.44 | 0.34 |
| Opal C/T | 0.00 | 0 |
| Diatomite 4 | 1.99 | 0.09 |
| Diatomite 5 | 0.17 | 0.09 |
| Expanded perlite high in | 0.15 | 0.52 |
| quartz | | |
| Perlite fines | 0.28 | 0.52 |
| Perlite commercial sample | 0.17 | 0.28 |
| Blast Furnace Slag | 0.21 | 0.29 |
| Calcium Silicate Slag | 1.76 | 10.97 |
| Wollastonite 1 | 6.63 | 13.55 |
| Wollastonite 2 | 3.40 | 11.79 |
| Wollastonite 3 | 2.30 | 17.08 |
| Wollastonite 4 | 3.11 | 7.56 |
| Wollastonite 5 | 1.83 | 3.67 |
| Wollastonite 6 | 2.53 | 15.22 |
| Wollastonite 7 | 2.76 | 9.1 |
| Wollastonite 8 | 0.98 | 12.15 |
| Vermiculite | 2.89 | 12.86 |
| Exfoliated vermiculite | 0.26 | 2.86 |
| Zeolite | 0.31 | 1.51 |
| Kaolinite 1 | 0.16 | 1.14 |
| Kaolinite 2 | 0.03 | 0.09 |
| Bentonite 1 | 0.00 | 0 |
| Bentonite 2 | 0.08 | 0.1 |
| Bentonite 3 | 0.24 | 0.19 |
| Bentonite 4 | 0.13 | 0.19 |
| Bentonite 5 | 0.08 | 0.19 |
| Bentonite 6 | 0.27 | 0.3 |
| Talc/Chlorite | 0.17 | 0.19 |
| Talc | 0.11 | 0.09 |
| Diatomite 1 | 0.08 | 0 |

1. A seed coating formulation comprising a silicate mineral and a binder, wherein the silicate mineral has a Si availability of at least about 3% according to the acid extraction method and/or at least about 1% according to the alkaline extraction method.

2. The seed coating formulation of claim 1, wherein the silicate mineral has a Si availability of at least about 5% according to the acid extraction method.

3. The seed coating formulation of claim 1, wherein the silicate mineral has a Si availability of at least about 2% according to the alkaline extraction method.

4. The seed coating formulation of claim 1, wherein the silicate mineral comprises an inosilicate.

5. The seed coating formulation of claim 1, wherein the silicate mineral comprises an alkaline earth metal silicate.

6. The seed coating formulation of claim 1, wherein the silicate mineral comprises a calcium silicate.

7. The seed coating formulation of claim 1, wherein the seed coating formulation further comprises calcium carbonate (CaCO₃).

8. The seed coating formulation of claim 1, wherein the silicate mineral comprises quartz (SiO₂).

9. The seed coating formulation of claim 1, wherein the silicate mineral comprises one or more of wollastonite (CaSiO₃), mica, diatomite, feldspar and talc.

10. The seed coating formulation of claim 1, wherein the silicate mineral has an average particle size ranging from about 5 μm to about 150 μm.

11. A seed having a coating comprising a silicate mineral and a binder, wherein the silicate mineral has a Si availability of at least about 3% according to the acid extraction method and/or at least about 1% according to the alkaline extraction method.

12. The seed of claim 11, wherein the silicate mineral has a Si availability of at least about 5% according to the acid extraction method.

13. The seed of claim 11, wherein the silicate mineral has a Si availability of at least about 2% according to the alkaline extraction method.

14. The seed of claim 11, wherein the silicate mineral comprises an inosilicate.

15. The seed of claim 11, wherein the silicate mineral comprises an alkaline earth metal silicate.

16. The seed of claim 11, wherein the silicate mineral comprises a calcium silicate.

17. The seed of claim 11, wherein the seed coating further comprises calcium carboante (CaCO₃).

18. The seed of claim 11, wherein the silicate mineral comprises quartz (SiO₂) and/or one or more of wollastonite (CaSiO3), mica, diatomite, feldspar and talc.

19. (canceled)

20. The seed of claim 11, wherein the silicate mineral has an average particle size ranging from about 5 μm to about 150 μm.

21. A method for coating a seed, the method comprising coating the seed with a seed coating formulation according to claim 1.

22-24. (canceled)
